(19) United States
(12) Patent Application Publication
(10) Pub. No.: US 2011/0106156 A1
(43) Pub. Date: May 5, 2011

(54) PACIFIER AND FEEDING DEVICE

(76) Inventor: Stephen Arbib, North York (CA)

(21) Appl. No.: 12/609,500

(22) Filed: Oct. 30, 2009

(51) Int. Cl. A61J 17/00; B26B 11/00

(52) U.S. Cl. 606/234; 30/123

(57) ABSTRACT

Disclosed is a combined pacifier and spoon device comprising a handle attached to a sucking body. The sucking body comprises a posterior region proximal to the handle and an anterior end distal to the handle. A curved upper side of the sucking body defines a recess extending at least part way between the posterior region and the anterior end thereof thereby forming a spoon for feeding food to a person with the recess for holding the food.

The present invention relates generally to pacifiers and in particular to a combined pacifier and spoon device for feeding or soothing an infant.

### BACKGROUND OF THE INVENTION

Infants and small children typically feed upon a number of soft food items such as pureed food, and/or a number of beverage items including frozen beverages. Frozen liquids can become a mixture or slurry of frozen and liquid material after the child is given the food and it begins to melt.

Infants and small children also often use teething rings or pacifiers to stop teething pain. Some commercially available pacifiers are solid, and of a flexible material such as rubber or plastic. Other pacifiers have a liquid filled interior such as a rubber or plastic pacifier having water on its inside.

Pacifier-like dispensing devices have been introduced which have a cylindrical chamber and a push rod for forcing liquid from the chamber through a pacifier or nipple dispensing end portion. Thus, infants and small children can obtain sustenance via these pacifier like devices. Another, similar device allows the child's normal squeezing pressure upon the apparatus to produce the dispensing of the food/beverage product.

However, such dispensing devices can be complex, making them relatively expensive and unwieldy. Accordingly, it is an object of the present invention to obviate or mitigate at least some of the problems of the prior art.

### SUMMARY

The present invention provides a relatively simple dispensing device. In accordance with one aspect of the present invention there is provided a combined pacifier and spoon comprising a handle; a sucking body attached to the handle, the sucking body comprising: a posterior region proximal to the handle; an anterior end distal to the handle; and a curved upper side defining a recess extending at least part way between the posterior region and the anterior end thereof thereby forming a spoon for feeding food to a person, the recess for holding the food.

According to another aspect of the invention the sucking body is made of silicone.

According to another aspect of the invention at least one of the handle and the sucking body change color in response to temperature.

According to another aspect of the invention the recess extends the entire length of the sucking body.

According to another aspect of the invention the handle is hingedly attached to a ring opposite the sucking body, ring defining an aperture.

According to another aspect of the invention the combined pacifier and spoon further comprises a guard, the guard attached between the handle and the sucking body, the guard for preventing both the sucking body and the handle from entering a person's mouth.

### BRIEF DESCRIPTION OF THE DRAWINGS

Embodiments of the present invention will now be described by way of example only with reference to the following drawings in which:

FIG. 1 is a top plan view of an exemplary embodiment of a combined pacifier and spoon in accordance with the present invention;

FIG. 2 is a side plan view of an exemplary embodiment of a combined pacifier and spoon in accordance with the present invention;

FIG. 3 is a side plan view of an exemplary embodiment of a combined pacifier and spoon with food in the spoon in accordance with the present invention; and

FIG. 4 is a side plan view of an exemplary embodiment of a combined pacifier and spoon showing in accordance with the present invention.

### DETAILED DESCRIPTION

For convenience, like numerals in the description refer to like structures in the drawings. Further, for ease of explanation only, the following description will refer only to infants. However, a person of ordinary skill in the art will appreciate that the teachings may also be applied to others, such as small children, for example.

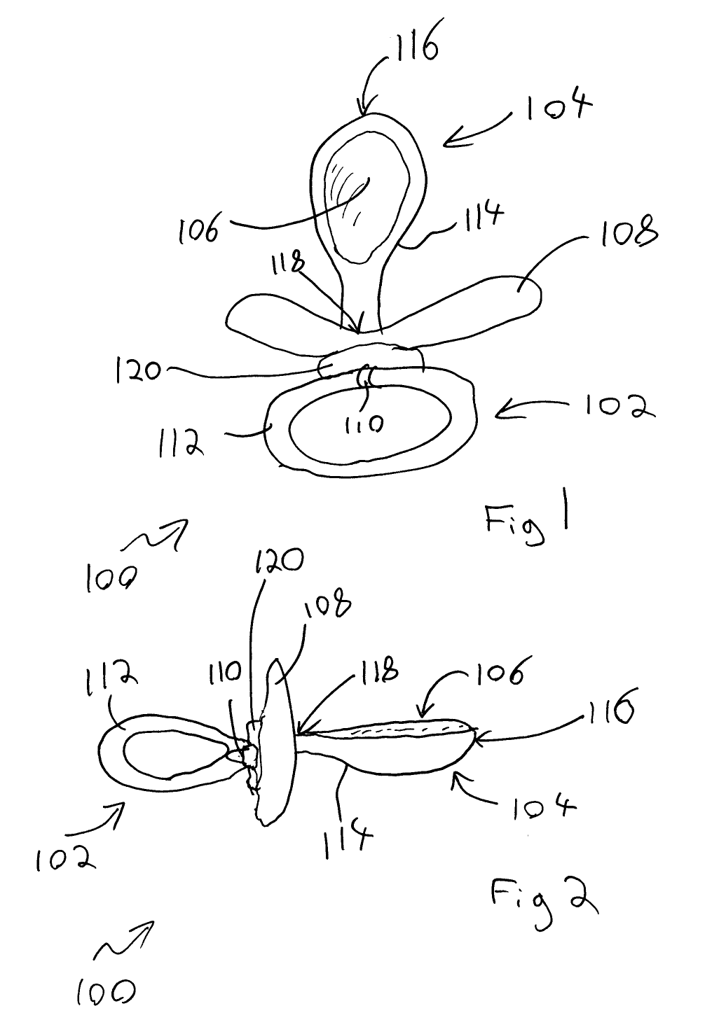

Referring to FIG. 1, a combined pacifier and spoon is shown generally at 100. The combined pacifier and spoon 100 comprises a sucking body 114 attached to a handle 120, which may itself be hingedly attached to a ring 102. A guard 108 is attached between the handle 120 and the sucking body 114.

The sucking body 114 has a posterior region 118 proximal to the handle 120 and an anterior end 116 distal to the handle 120. A curved upper side defining a recess 106 extends between the posterior region 118 and the anterior end 116 of the sucking body 120.

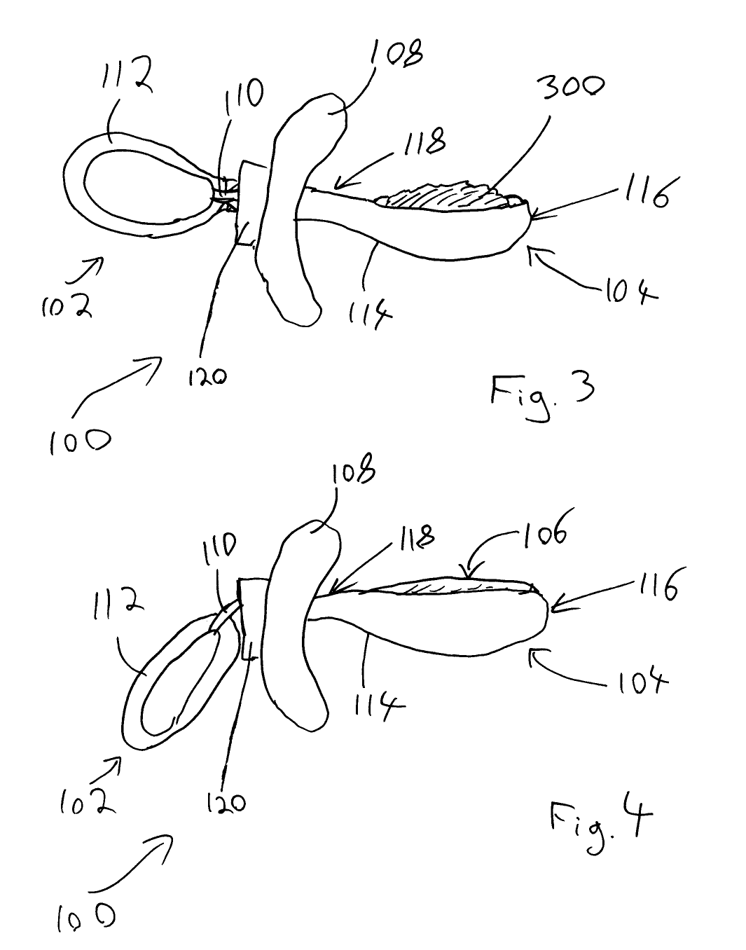

The curved upper side of the handle 120 together with the recess 106 form a spoon for feeding food 300 (see FIG. 3) to an infant, with the recess 106 holding the food 300.

Between the handle 120 and the sucking body 114 there is a guard 108. The guard 108 is a curved surface having a concave side directed towards the sucking body 114 and a convex side directed towards the handle. In the embodiment shown in the figures, the handle 120 (and hence the sucking body 114) extends through the centre of the surface of the guard 108 and hence the centre of the concave and convex surfaces.

The guard 108 may be curved at the edges so as to prevent injury to the infant who may be using the combined pacifier and spoon 100.

In an embodiment the guard 108 may be secured by a friction fit to either the handle 120 or the sucking body 114. Alternatively, the guard 108 may be integrally formed with at least one of the handle 120 or the sucking body 114.

The guard 108 is shaped and configured to abut against the mouth of the infant to prevent the entire combined pacifier and spoon 100 from entering the person's mouth, thereby preventing choking Thus, the guard 108 prevents both the handle 120 and the sucking body 114 from entering the mouth simultaneously.

A hinge 110 attaches a ring 112 to the end of the handle 120 opposite the sucking body 114, thereby hingedly securing the ring 112 to the handle 120. The hinge 110 attachment allows the ring to swivel and rotate in relation to the handle 120 (see FIG. 4 for example). According to an embodiment, the ring 112 is fabricated from rigid material such as plastic and forms a circle defining an aperture. The aperture may, for example, be sized such that the infant's finger can fit there through to provide easy grasping of the combined pacifier and spoon 100. It is recognized, however, that the ring need not define an aperture.

Additionally, the ring 122 may be fabricated from different material from any or all of the handle 120, sucking body 114 and guard 108.

The sucking body 114 may be made of silicone or other material suitable for having an infant eat of off and/or suck on.

The recess 106 of the sucking body 114 forms a spoon that can hold and transport food 300 to a mouth of a person. The recess 106 is configured and sized to hold an amount of food that is a comfortable spoon-sized serving for the infant. The size of the recess 106 may thereby vary between different embodiments to cater to the needs of infants and small childrens of different ages. The edges and sides of the sucking body 114 may be curved so as to prevent injury to the infant.

The recess 106 of the embodiments shown in the Figures extends part way between the anterior end 116 and the posterior region 118 of the sucking body 114. In accordance with another embodiment, the side of the sucking body 114 opposite the recess 106 extends substantially flat in the longitudinal direction.

The combined pacifier and spoon 100 can be used to both pacify and feed the infant. However, the principal use of the combined pacifier and spoon 100 is intended to be for feeding the infant. In use, an adult, or other responsible person, will scoop food into the recess 106 of the combined pacifier and spoon 100 and place it in the infant's mouth. The natural instinct of the infant to suck on the combined pacifier and spoon 100 will cause the infant to ingest the food from the recess 106, thus assisting the infant with learning to eat.

In accordance with another embodiment of the present invention the material of at least one of the sucking body 114, the guard 108 or the handle 120 is made from a temperature sensitive material such that the respective sucking body 114, guard 108 or handle 120 changes colour if and when the temperature reaches a certain level.

Although the description refers to a particular shape and configuration of the guard 108 and the handle 120, the invention is not limited to such a configuration. A person of ordinary skill in the art will appreciate that there are a number of different configuration for the guard 108 and the handle 120, many, if not all, of which may be implemented in conjunction with the sucking body 114 described herein.

One or more currently preferred embodiments have been described by way of example. It will be apparent to persons skilled in the art that a number of variations and modifications can be made without departing from the scope of the invention as defined in the claims.

What is claimed is:

1. A combined pacifier and spoon comprising:
a handle;
a sucking body attached to the handle, the sucking body comprising:
a posterior region proximal to the handle;
an anterior end distal to the handle; and
a curved upper side defining a recess extending at least part way between the posterior region and the anterior end thereof thereby forming a spoon for feeding food to a person, the recess configured for holding the food.

2. The combined pacifier and spoon of claim 1, wherein the sucking body is made of silicone.

3. The combined pacifier and spoon of claim 1, wherein at least one of the handle and the sucking body change colour in response to temperature.

4. The combined pacifier and spoon of claim 1, wherein the recess extends the entire length of the sucking body.

5. The combined pacifier and spoon of claim 1, wherein the handle is hingedly attached to a ring opposite the sucking body.

6. The combined pacifier and spoon of claim 5, the ring defining an aperture.

7. The combined pacifier and spoon of claim 1 further comprising a guard, the guard attached between the handle and the sucking body, the guard for preventing both the sucking body and the handle from entering a person's mouth.
